(19) United States
(12) Patent Application Publication
(10) Pub. No.: US 2023/0335145 A1
(43) Pub. Date: Oct. 19, 2023

(54) SIGNAL COMPRESSION METHOD AND APPARATUS, AND SIGNAL RESTORATION METHOD AND APPARATUS

(71) Applicants: Electronics and Telecommunications Research Institute, Daejeon (KR); Kyungpook National University Industry-Academic Cooperation Foundation, Daegu (KR)

(72) Inventors: Woo-taek LIM, Daejeon (KR); Seung Kwon BEACK, Daejeon (KR); Jongmo SUNG, Daejeon (KR); Tae Jin LEE, Daejeon (KR); Inseon JANG, Daejeon (KR); Min Han KIM, Daegu (KR); Seung Hyeon SHIN, Daegu (KR); Dae Ho LEE, Daegu (KR); Seok Jin LEE, Daegu (KR)

(73) Assignees: Electronics and Telecommunications Research Institute, Daejeon (KR); Kyungpook National University Industry-Academic Cooperation Foundation, Daegu (KR)

(21) Appl. No.: 18/118,604

(22) Filed: Mar. 7, 2023

(30) Foreign Application Priority Data
Apr. 13, 2022 (KR) 10-2022-0045799

(51) Int. Cl. G10L 19/06; G10L 19/032

(52) U.S. Cl. CPC G10L 19/06; G10L 19/032

(57) ABSTRACT

A signal compression method and apparatus and a signal restoration method and apparatus are provided. The signal compression method includes outputting an input signal, obtained by processing an audio signal, which is input, based on a human auditory perception characteristic, using an auditory perception model, extracting a feature vector from the input signal using a feature extraction module, and outputting a code obtained by compressing the feature vector using a trained signal compression model.

### CROSS-REFERENCE TO RELATED APPLICATION

This application claims the benefit of Korean Patent Application No. 10-2022-0045799 filed on Apr. 13, 2022, in the Korean Intellectual Property Office, the entire disclosure of which is incorporated herein by reference for all purposes.

### BACKGROUND

### 1. Field of the Invention

One or more embodiments relate to a signal compression method and apparatus, and a signal restoration method and apparatus.

### 2. Description of the Related Art

Through acoustic signal processing to perform an operation and analyze acoustic data by processing the acoustic data, a signal given as a waveform may be processed through an appropriate operation and analyzed as information that humans can understand, which may have a significant influence on the overall performance of a system with an acoustic signal as a medium.

When features of a data set are learned through a machine learning scheme, features of data that are advantageous to learning and features that hinder learning may be processed through preprocessing, to learn meaningful features of the data set.

In acoustic signal processing, acoustic signals may be processed based on criteria used by humans for auditory perception, using a Mel filterbank and a gammatone filterbank using filters that are based on features of a human auditory model.

### SUMMARY

One or more embodiments provide a signal compression technology for an audio signal, or an acoustic signal using machine learning and provide an auditory model reflection scheme reflecting human auditory perception characteristics.

One or more embodiments provide a signal processing method of extracting a feature from an audio signal by reflecting a characteristic of an auditory model used by a human to perceive sound, and compressing and restoring a signal using the extracted feature, for example, encoding and decoding the signal.

One or more embodiments provide a method of extracting a feature from an audio signal by modeling a human auditory system, and provide a machine learning-based signal compression model for compressing and restoring the extracted feature.

According to an aspect, there is provided a signal compression method including outputting an input signal, obtained by processing an audio signal, which is input, based on a human auditory perception characteristic, using an auditory perception model, extracting a feature vector from the input signal using a feature extraction module, and outputting a code obtained by compressing the feature vector using a trained signal compression model.

The outputting of the input signal may include filtering the audio signal using a middle ear filter, determining a first control variable of a step subsequent to a previous step, based on the filtered audio signal and a second control variable according to a first control variable of the previous step, using an outer hair cell group, and outputting the input signal based on the filtered audio signal and the first control variable of the subsequent step, using an inner hair cell group.

The inner hair cell group may include a chirping filter, a low-pass filter, and a wideband filter, and may be configured to output the input signal, based on a characteristic of the chirping filter determined based on the first control variable of the subsequent step.

The outer hair cell group may include a control path filter, and a low-pass filter, and may be configured to determine the first control variable of the subsequent step based on a characteristic of the control path filter determined based on the second control variable.

The signal compression model may include a first neural network model trained to output a latent vector using the feature vector, and a quantization model trained to output the code based on the latent vector and a codebook.

According to another aspect, there is provided a signal compression apparatus including a processor, wherein the processor is configured to output an input signal, obtained by processing an audio signal, which is input, based on a human auditory perception characteristic, using an auditory perception model, extract a feature vector from the input signal, using a feature extraction module, and output a code obtained by compressing the feature vector, using a trained signal compression model.

The auditory perception model may include a middle ear filter configured to filter the audio signal, an outer hair cell group configured to determine a first control variable of a step subsequent to a previous step based on the filtered audio signal and a second control variable according to a first control variable of the previous step, and an inner hair cell group configured to output the input signal based on the filtered audio signal and the first control variable of the subsequent step.

The inner hair cell group may include a chirping filter, a low-pass filter, and a wideband filter, and may be configured to output the input signal, based on a characteristic of the chirping filter determined based on the first control variable of the subsequent step.

The outer hair cell group may include a control path filter, and a low-pass filter, and may be configured to determine the first control variable of the subsequent step based on a characteristic of the control path filter determined based on the second control variable.

The signal compression model may include a first neural network model trained to output a latent vector using the feature vector, and a quantization model trained to output the code based on the latent vector and a codebook.

According to another aspect, there is provided a signal restoration apparatus including a processor, wherein the processor is configured to identify a code, and output an output signal restored from the code using a trained signal restoration model, wherein the code is output by compressing a feature vector using a trained signal compression model, and wherein the feature vector is extracted from an input signal, obtained by processing an audio signal, which is input, based on a human auditory perception characteristic, using an auditory perception model.

The auditory perception model may include a middle ear filter configured to filter the audio signal, an outer hair cell group configured to determine a first control variable of a step subsequent to a previous step based on the filtered audio signal and a second control variable according to a first control variable of the previous step, and an inner hair cell group configured to output the input signal based on the filtered audio signal and the first control variable of the subsequent step.

The inner hair cell group may include a chirping filter, a low-pass filter, and a wideband filter, and may be configured to output the input signal, based on a characteristic of the chirping filter determined based on the first control variable of the subsequent step.

The outer hair cell group may include a control path filter, and a low-pass filter, and may be configured to determine the first control variable of the subsequent step based on a characteristic of the control path filter determined based on the second control variable.

The signal restoration model may include an inverse quantization model configured to restore a latent vector from the code using a codebook, and a second neural network model configured to restore the output signal using the latent vector.

The signal compression model may include a first neural network model trained to output a latent vector using the input signal, and a quantization model trained to output the code based on the latent vector and a codebook.

The signal restoration model, the signal compression model, and the codebook may be trained based on a loss function determined based on the feature vector, the latent vector, the code, and the output signal.

Additional aspects of embodiments will be set forth in part in the description which follows and, in part, will be apparent from the description, or may be learned by practice of the disclosure.

According to embodiments, a feature value, for example, a feature vector, may be extracted based on a human auditory characteristic model, and the extracted feature vector may be applied to a machine learning-based acoustic signal compression system, to enhance a hearing-related quality of a restored audio signal.

According to embodiments, it is possible to enhance a hearing-related quality of a restored audio signal, using a feature vector extracted based on a human auditory characteristic model, in consideration of a characteristic of a loss compression system in which a portion of data of an audio signal is lost.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating operations of a signal compression apparatus and a signal restoration apparatus according to an embodiment;

FIG. 2 is a diagram illustrating operations of a signal compression apparatus and a signal restoration apparatus according to an embodiment;

FIG. 3 is a diagram illustrating an operation of outputting an input signal using an auditory perception model according to an embodiment;

FIG. 4 is a diagram illustrating operations of a signal compression model and a signal restoration model according to an embodiment:

FIG. 5 is a diagram illustrating an example of a signal compression method according to an embodiment:

FIG. 6 is a diagram illustrating another example of a signal compression method according to an embodiment:

FIG. 7 is a diagram illustrating an example of a signal restoration method according to an embodiment; and

FIG. 8 is a diagram illustrating another example of a signal restoration method according to an embodiment.

### DETAILED DESCRIPTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. Terms defined in dictionaries generally used should be construed to have meanings matching with contextual meanings in the related art and are not to be construed as an ideal or excessively formal meaning unless otherwise defined herein.

When describing the embodiments with reference to the accompanying drawings, like reference numerals refer to like constituent elements and a repeated description related thereto will be omitted. In the description of embodiments, detailed description of well-known related structures or functions will be omitted when it is deemed that such description will cause ambiguous interpretation of the present disclosure.

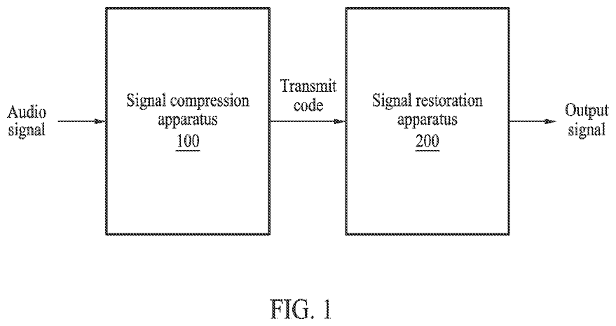

FIG. 1 is a diagram illustrating operations of a signal compression apparatus 100 and a signal restoration apparatus 200 according to an embodiment.

Referring to FIG. 1, the signal compression apparatus 100 may extract a feature vector using an audio signal that is input. For example, the signal compression apparatus 100 may output an input signal obtained by processing an audio signal based on a human auditory perception characteristic. The signal compression apparatus 100 may extract a feature vector using the input signal. The signal compression apparatus 100 may transmit a code obtained by compressing the extracted feature vector to the signal restoration apparatus 200.

The signal restoration apparatus 200 may receive the code from the signal compression apparatus 100 and output an output signal using the received code. For example, the output signal may correspond to the input signal obtained by processing the audio signal in the signal compression apparatus 100.

Referring to FIG. 1, the signal compression apparatus 100 may process the audio signal based on the human auditory perception characteristic and extract the feature vector, so that the output signal restored in the signal restoration apparatus 200 may meet the human auditory 1s perception characteristic, to enhance a sense of hearing for the output signal.

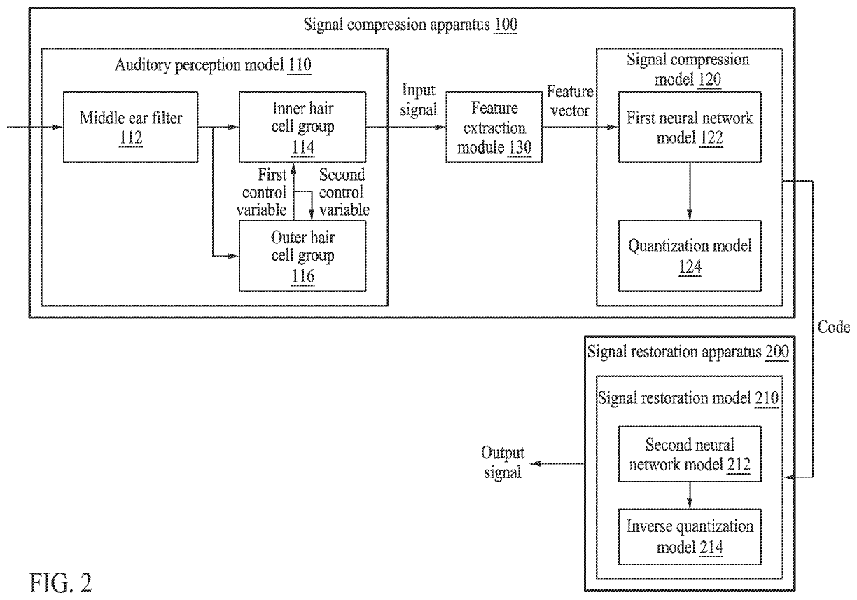

FIG. 2 is a diagram illustrating operations of a signal compression apparatus 100 and a signal restoration apparatus 200 according to an embodiment.

Referring to FIG. 2, the signal compression apparatus 100 may include a processor, an auditory perception model 110, a feature extraction module 130, and a signal compression model 120.

In an example, the signal compression apparatus 100 may process an audio signal, which is input, based on a human auditory perception characteristic, using the auditory perception model 110, and may output the input signal. For example, the auditory perception model 110 may include a middle ear filter 112, an inner hair cell group 114, or an outer hair cell group 116.

The signal compression apparatus 100 may convert the audio signal according to the human auditory perception characteristic, using the middle ear filter 112. For example, the middle ear filter 112 may filter the audio signal. The audio signal filtered by the middle ear filter 112 may be input to the outer hair cell group 116 and the inner hair cell group 114. For example, the middle ear filter 112 may mimic an operation of a middle ear among human auditory perception organs. The middle ear filter 112 may filter the audio signal as if a middle ear converts sound.

In an example, the outer hair cell group 116 may output a first control variable. The first control variable may refer to a parameter to determine a characteristic of the inner hair cell group 114, for example, a characteristic of a filter included in the inner hair cell group 114.

In an example, the first control variable output from the outer hair cell group 116 may be input to the outer hair cell group 116 again according to a feed-forward scheme. For example, the filtered audio signal, and the first control variable output from the outer hair cell group 116 in a previous step may be input to the outer hair cell group 116.

For example, the outer hair cell group 116 may determine a first control variable of a step subsequent to the previous step, based on the filtered audio signal and a second control variable according to the first control variable of the previous step. The second control variable may refer to a parameter to determine a characteristic of the outer hair cell group 116, for example, a filter included in the outer hair cell group 116.

For example, the inner hair cell group 114 may output an input signal based on the filtered audio signal and the first control variable.

For example, a characteristic frequency, a frequency band, a time constant, a value for correcting a frequency response, and a value for a delay time of the inner hair cell group 114 may be determined based on the input first control variable.

In an example, the outer hair cell group 116 may mimic an operation of controlling an operation of an inner hair cell according to a characteristic of an input signal in an outer hair cell among human auditory perception organs. In an example, the inner hair cell group 114 may mimic an operation of converting a signal so that a human brain may perceive sound in inner hair cells having different sensitivities or characteristic frequencies among human auditory perception organs.

In an example, the signal compression apparatus 100 may convert an input signal to a feature vector, using the feature extraction module 130. For example, the signal compression apparatus 100 may convert the input signal to the feature vector to be input to the signal compression model 120.

In an example, the signal compression apparatus 100 may output a code using the signal compression model 120. For example, the code may refer to an audio signal or an input signal that is mapped in the form of a codebook and compressed. The signal compression apparatus 100 may output a code obtained by compressing the input signal using the signal compression model 120.

In an example, the signal compression model 120 may include a first neural network model 122, and a quantization model 124. The first neural network model 122 may output a latent vector using the feature vector. The quantization model 124 may output a code based on the latent vector and the codebook. For example, the signal compression apparatus 100 may compare the latent vector output from the first neural network model 122 to embedding vectors of the codebook of the quantization model 124, and may output a code indicating an embedding vector closest to the latent vector.

For example, an autoencoder such as a vector quantized-variational autoencoder (VQ-VAE) may be applied to the signal compression model 120. The signal compression model 120 may be trained based on a small quantity of data by discretizing continuous data of a variational autoencoder using a codebook obtained by quantizing vectors.

For example, a feature vector input to the signal compression model 120 may be represented in two dimensions (2D). The first neural network model 122 may include a convolutional neural network (CNN) that analyzes an image pattern.

In an example, the signal restoration apparatus 200 may include a processor, and a signal restoration model 210. In an example, the signal restoration apparatus 200 may output an output signal using the signal restoration model 210. The signal restoration model 210 may include a second neural network model 212, and an inverse quantization model 214.

The signal restoration apparatus 200 may output a latent vector using the inverse quantization model 214. The inverse quantization model 214 may output a latent vector using the input code. The signal restoration apparatus 200 may restore an output signal by inputting the latent vector output from the inverse quantization model 214 to the second neural network model 212.

For example, the second neural network model 212 may be trained to output an output signal obtained by restoring the audio signal using the input latent vector. For example, the output signal output from the second neural network model 212 may refer to a signal obtained by restoring an audio signal input to the signal compression apparatus 100.

For example, the second neural network model 212 may be trained to output an output signal obtained by restoring the audio signal using the input latent vector. For example, the output signal output from the second neural network model 212 may refer to a signal obtained by restoring the input signal that is output from the auditory perception model 110 of the signal compression apparatus 100.

For example, the auditory perception model 110 may convert an input audio signal into an input signal, and inversely convert an input signal into an audio signal. For example, when the output signal is a signal obtained by restoring the input signal that is output from the auditory perception model 110, the signal restoration apparatus 200 may further include an auditory perception model (not shown). The signal restoration apparatus 200 may convert the input signal that is output from the second neural network model 212 into an audio signal, using the auditory perception model.

For example, the output signal output from the second neural network model 212 may bean acoustic signal or an audio signal. The second neural network model 212 may be trained to restore the input signal that is output from the auditory perception model 110. The second neural network model 212 may include, for example, a neural network model that may generate an acoustic waveform of a time axis.

For example, a wave recurrent neural network (WaveRNN) may be used as the second neural network model 212. For example, the second neural network model 212 may divide a 16-bit sample into two 8-bit samples, e.g., a coarse bit and a fine bit. The second neural network model 212 may individually input the coarse bit and the fine bit to a softmax layer, predict a coarse bit, and predict a fine bit using the predicted coarse bit.

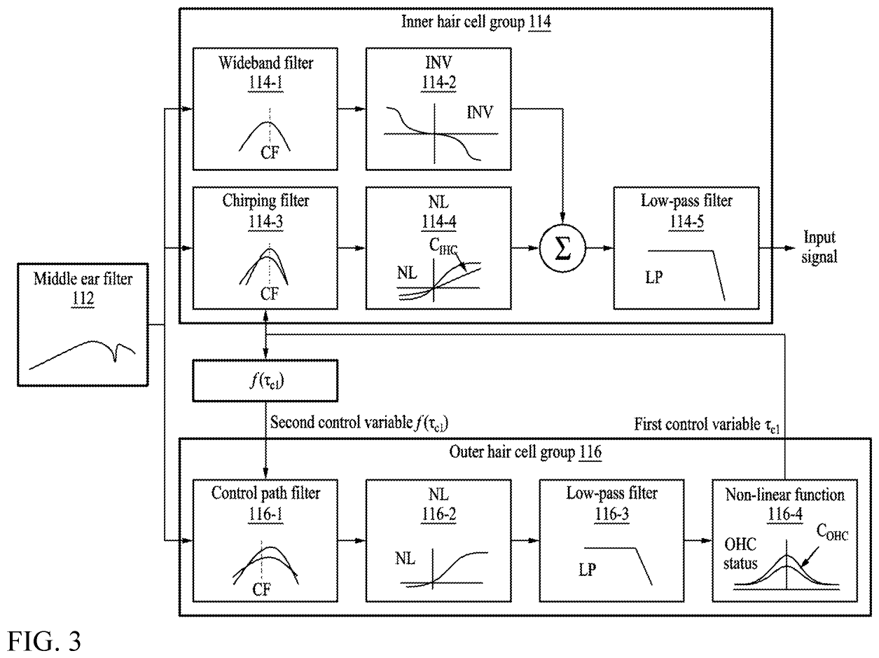

FIG. 3 is a diagram illustrating an operation of outputting an input signal using an auditory perception model 110 according to an embodiment.

Referring to FIG. 3, the auditory perception model 110 may include a middle ear filter 112, an inner hair cell group 114, or an outer hair cell group 116. For example, the inner hair cell group 114 may include bandpass filters (e.g., a wideband filter 114-1, and a chirping filter 114-3 of FIG. 3), an inverting nonlinearity (INV) filter (e.g., an INV function 114-2 of FIG. 3), a non-linear (NL) filter (e.g., an NL function 114-4 of FIG. 3), or a low-pass filter 114-5. For example, the outer hair cell group 116 may include a control path filter 116-1, and a low-pass filter 116-3.

FIG. 3 illustrates an example of the auditory perception model 110 among various examples, and embodiments are not limited to the inner hair cell group 114 and the outer hair cell group 116 of the auditory perception model 110 of FIG. 3. For example, the inner hair cell group 114 may include the INV function 114-2, the NL function 114-4, and the low-pass filter 114-5. The outer hair cell group 116 may include a non-linear filter (e.g., an NL function 116-2 of FIG. 3), the low-pass filter 116-3, and an NL function 116-4. The bandpass filters (e.g., the wideband filter 114-1, and the chirping filter 114-3), and the control path filter 116-1 may be included in the auditory perception model 110.

In an example, the middle ear filter 112 may filter an input audio signal. The middle ear filter 112 may filter the audio signal, similarly to a characteristic of a human middle ear that converts sound energy into mechanical energy. The filtered audio signal may be input to the control path filter 116-1 of the outer hair cell group 116. The filtered audio signal may be input to the bandpass filters (e.g., the wideband filter 114-1, and the chirping filter 114-3) of the inner hair cell group 114.

In an example, the signal compression apparatus 100 may output a first control variable using the outer hair cell group 116. The signal compression apparatus 100 may determine a second control variable of a current step, based on a first control variable of a previous step. For example, the signal compression apparatus 100 may determine a second control variable f(τ_{c1}) of a subsequent step based on the first control variable τ_{c1} of the previous step.

The outer hair cell group 116 may determine a first control variable of a step subsequent to the previous step based on the filtered audio signal and the second control variable. For example, the outer hair cell group 116 may process the filtered audio signal according to the control path filter 116-1, the NL function 116-2, the low-pass filter 116-3, and the NL function 116-4. In an example, a characteristic, for example, a characteristic frequency and a frequency band, of the control path filter 116-1, may be determined based on the second control variable.

For example, the signal compression apparatus 100 may output an input signal using the inner hair cell group 114. The filtered audio signal may be input to the wideband filter 114-1 and the chirping filter 114-3 of the inner hair cell group 114. The signal compression apparatus 100 may process an audio signal filtered through the wideband filter 114-1 according to the INV function 114-2, and may process an audio signal filtered through the chirping filter 114-3 according to the NL function 114-4. The signal compression apparatus 100 may sum the audio signals processed according to the INV function 114-2 and the NL function 114-4 and output the input signal using the low-pass filter 114-5.

For example, a characteristic of the chirping filter 114-3 of the inner hair cell group 114 may be determined based on the first control variable. For example, the characteristic of the chirping filter 114-3, for example, a time constant, a value for correcting a frequency response, a delay time, and a characteristic frequency, may be determined based on the first control variable.

As shown in FIG. 3, the auditory perception model 110 may convert an input audio signal into an input signal, based on a human auditory perception characteristic. The middle ear filter 112 may filter the input audio signal according to a characteristic of a waveform of the input audio signal. The outer hair cell group 116 may process the filtered audio signal according to a second control variable and output the first control variable. The inner hair cell group 114 may process the filtered audio signal using a characteristic of a filter determined according to the first control variable, and may output the input signal.

The middle ear filter 112, the inner hair cell group 114, and the outer hair cell group 116 included in the auditory perception model 110 shown in FIG. 3 merely correspond to one embodiment among various embodiments, and various auditory perception models 110 other than the auditory perception model 110 of FIG. 3 may be applied.

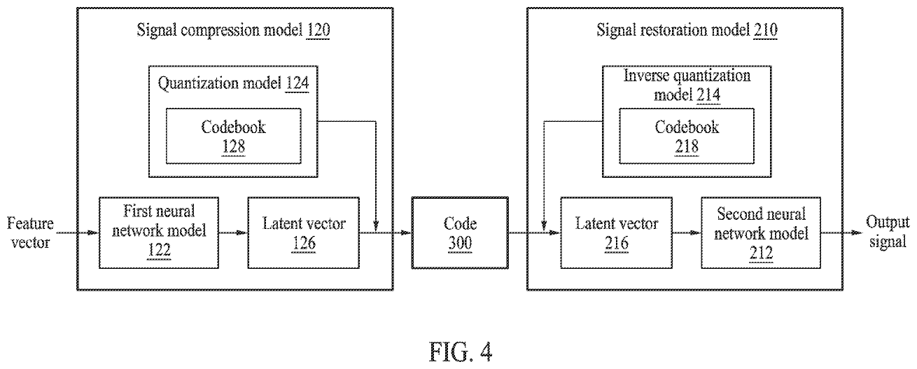

FIG. 4 is a diagram illustrating operations of a signal compression model 120 and a signal restoration model 210 according to an embodiment.

Referring to FIG. 4, the signal compression model 120 may output a code 300 using an input feature vector, and the signal restoration model 210 may output an output signal using the code 300 that is input from the signal compression model 120.

For example, a first neural network model 122 may be trained to output a latent vector 126 using the input feature vector. A quantization model 124 may output the code 300 corresponding to the latent vector 126 using a codebook 128. For example, the codebook 128 may include embedding vectors, and the quantization model 124 may compare the latent vector 126 to the embedding vectors. The quantization model 124 may output the code 300 indicating an embedding vector closest to the latent vector 126.

For example, the signal restoration model 210 may output an output signal using the input code 300. An inverse quantization model 214 may obtain a latent vector 216 by restoring the input code 300 using a codebook 218.

For example, the inverse quantization model 214 may output the latent vector 216 corresponding to the code 300. For example, the codebook 218 of the inverse quantization model 214 may include embedding vectors. The inverse quantization model 214 may determine the latent vector 216 using embedding vectors corresponding to the code 300 received from the signal compression apparatus 100. A second neural network model 212 may output an output signal using the latent vector 216.

In an example, the first neural network module 122, the codebook 128 of the quantization model 124 or the codebook 218 of the inverse quantization model 214, and the second neural network model 212 may be trained based on the feature vector, the latent vectors 126 and 216, the embedding vector, and the output signal. A loss function L of each of the signal compression model 120 and the signal restoration model 210 may be calculated as shown in Equation 1 below.

L=log p(x|z_{q}(x))+∥sg[zₑ(x)]−e∥₂²+β∥zₑ(x)−sg[e]∥₂² Equation 11

In Equation 1, x denotes the feature vector, z_{q}(x) denotes the latent vector 216 obtained by converting an input code in the inverse quantization model 214, zₑ(x) denotes the latent vector 126 output from the first neural network model 122, e| denotes the embedding vector, sg denotes a stop gradient, and β denotes a set weight. The code 300 may indicate an embedding vector.

The first neural network module 122, the codebook 128 of the quantization model 124 or the codebook 218 of the inverse quantization model 214, and the second neural network model 212 may be trained to minimize the loss function of Equation 1. The codebook 128 of the quantization model 124 may be the same as the codebook 218 of the inverse quantization model 214. For example, the embedding vectors of the codebook 128 of the quantization model 124 may be the same as the embedding vectors of the codebook 218 of the inverse quantization model 214.

In an example, the first neural network model 122, the codebooks 128 and 218, and the second neural network model 212 may be trained using the signal compression apparatus 100 and the signal restoration apparatus 200.

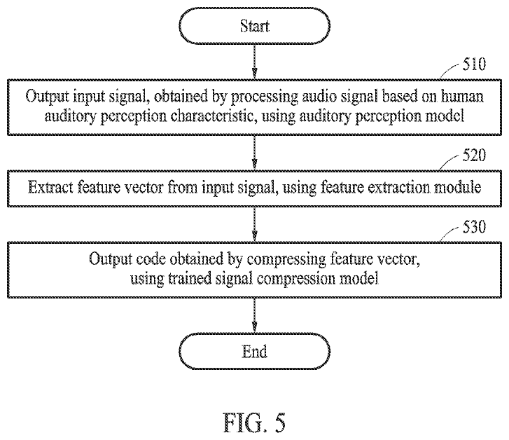

FIG. 5 is a diagram illustrating an example of a signal compression method according to an embodiment.

Referring to FIG. 5, in operation 510, the signal compression apparatus 100 according to various embodiments may output an input signal by processing an audio signal, which is input, using the auditory perception model 110. The auditory perception model 110 may process the audio signal based on a human auditory perception characteristic.

In operation 520, the signal compression apparatus 100 may extract a feature vector from the input signal using the feature extraction module 130. The extracted feature vector may be input to the first neural network model 122. For example, the feature extraction module 130 may extract a 2D feature vector, and the first neural network model 122 may include a CNN that may process the 2D feature vector.

In operation 530, the signal compression apparatus 100 may output a code obtained by compressing the feature vector using the signal compression model 120 that is trained. The signal compression apparatus 100 may transmit the code to the signal restoration apparatus 200. The signal restoration apparatus 200 may restore the received code and output an output signal.

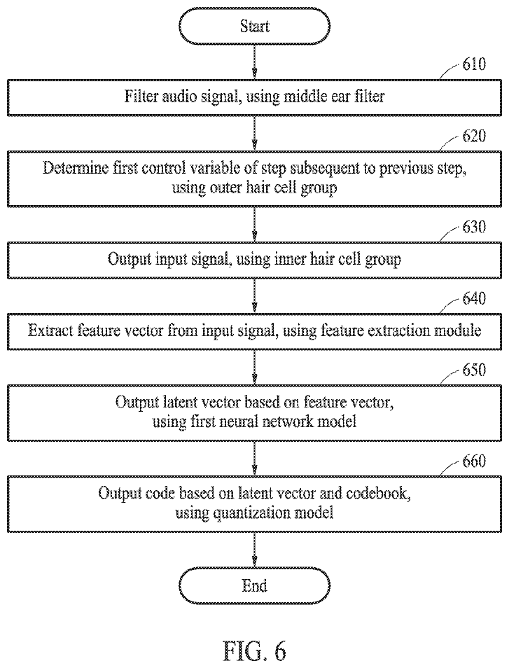

FIG. 6 is a diagram illustrating another example of a signal compression method according to an embodiment.

In operation 610, the signal compression apparatus 100 may filter an audio signal using the middle ear filter 112. For example, the middle ear filter 112 may filter the audio signal as if a middle ear of a human auditory perception organ converts sound. For example, the middle ear filter 112 may process the audio signal according to a waveform and a frequency of the audio signal. The audio signal input to the middle ear filter 112 may refer to a pressure waveform in units of pascals (Pa) changing over time.

In operation 620, the signal compression apparatus 100 may determine a first control variable using the outer hair cell group 116. The outer hair cell group 116 may determine the first control variable using a feed-forward scheme. For example, the outer hair cell group 116 may determine a second control variable of a subsequent step, based on a first control variable of a previous step. The outer hair cell group 116 may determine a first control variable of the subsequent step based on the filtered audio signal and the second control variable of the subsequent step.

For example, a characteristic of the outer hair cell group 116 may be determined based on a second control variable. For example, a characteristic frequency of a control path filter included in the outer hair cell group 116 may be determined based on the second control variable.

In operation 630, the signal compression apparatus 100 may output an input signal using the inner hair cell group 114. For example, the inner hair cell group 114 may include a bandpass filter and a low-pass filter. The audio signal filtered by the middle ear filter 112 may be input to a wideband filter and a chirping filter. The filtered audio signal processed by the wideband filter may be processed according to an INV function, and the filtered audio signal processed by the chirping filter may be processed according to an NL function. The filtered audio signals processed according to the INV function and the NL function may be summed and processed based on the low-pass filter.

For example, a characteristic of the inner hair cell group 114 may be determined based on a first control variable. A characteristic frequency, a time constant, a value for correcting a frequency response, a delay time, and the like of the chirping filter included in the inner hair cell group 114 may be determined based on the first control variable.

In operation 640, the signal compression apparatus 100 may extract a feature vector from the input signal using the feature extraction module 130. A feature vector output from the feature extraction module 130 may be, for example, a 2D vector. The feature vector may be input to the signal compression model 120.

In operation 650, the signal compression apparatus 100 may output a latent vector based on the feature vector, using the first neural network model 122 that is trained. The first neural network model 122 may be trained to output the latent vector using the input feature vector. The first neural network model 122 may output the latent vector by receiving a 2D feature vector, and may include a CNN. The latent vector output from the first neural network model 122 may refer to a discrete representation vector.

In operation 660, the signal compression apparatus 100 may output a code using the quantization model 124. For example, the quantization model 124 may output the code using a codebook including embedding vectors. For example, the signal compression apparatus 100 may compare the latent vector to an embedding vector and output a code indicating an embedding vector closest to the latent vector.

For example, the signal compression apparatus 100 may search for an embedding vector eⱼ spaced apart by a minimum distance from a latent vector zₑ(x), as in Equation 2 below. A discrete representation vector z may have a value of “1” at an index of an embedding vector spaced apart by a minimum distance from a latent vector. The discrete representation vector z may indicate a code.

$$q ( z = k \vert x ) = \{ \begin{matrix}1 & for k = {argmin}_{j} {‖ {z}_{e} ( x ) - {e}_{j} ‖}_{2} \\ 0 & otherwise\end{matrix} \qquad [ Equation 2 ]$$

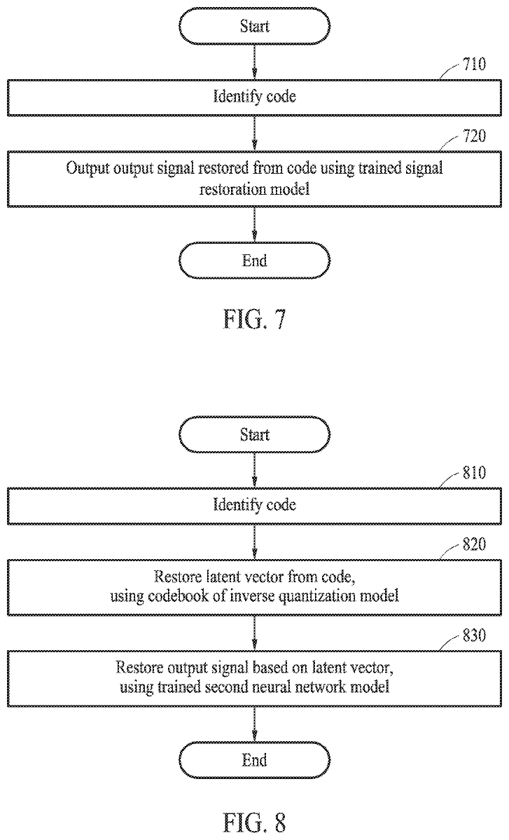

FIG. 7 is a diagram illustrating an example of a signal restoration method according to an embodiment.

Referring to FIG. 7, in operation 710, the signal restoration apparatus 200 may identify a code. For example, the signal restoration apparatus 200 may receive the code from the signal compression apparatus 100.

In operation 720, the signal restoration apparatus 200 may output an output signal restored from the code using the signal restoration model 210 that is trained. For example, the signal restoration model 210 may be trained to output an output signal that is obtained by restoring an input signal based on an input code. The input signal may refer to a signal obtained by processing an audio signal based on a human auditory perception characteristic in the auditory perception model 110 of the signal compression apparatus 100.

FIG. 8 is a diagram illustrating another example of a signal restoration method according to an embodiment.

In operation 810, the signal restoration apparatus 200 may identify a code. In operation 820, the signal restoration apparatus 200 may restore a latent vector from the code, using a codebook of the inverse quantization model 214. For example, the codebook may include embedding vectors. The inverse quantization model 214 may restore the latent vector using embedding vectors corresponding to the code.

In operation 830, the signal restoration apparatus 200 may restore an output signal based on the latent vector, using the second neural network model 212 that is trained. For example, the output signal may be an acoustic signal or an audio signal to be restored. The second neural network model 212 may include a WaveRNN, and may output an acoustic waveform having a time axis using an input latent vector.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The method according to embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The implementations may be achieved as a computer program product, for example, a computer program tangibly embodied in a machine readable storage device (a computer-readable medium) to process the operations of a data processing device, for example, a programmable processor, a computer, or a plurality of computers or to control the operations. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory (ROM) or a random access memory (RAM), or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, for example, magnetic media such as hard disks, floppy disks, and magnetic tape, optical media such as compact disc ROMs (CD-ROMs) or digital versatile discs (DVDs), magneto-optical media such as floptical disks, ROMs, RAMs, flash memories, erasable programmable ROMs (EPROMs), or electrically erasable programmable ROMs (EEPROMs). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific embodiments, the details should not be construed as limiting any invention or a scope that can be claimed, but rather should be construed as being descriptions of features that may be peculiar to specific embodiments of specific inventions. Specific features described in the present specification in the context of individual embodiments may be combined and implemented in a single embodiment. On the contrary, various features described in the context of a single embodiment may be implemented in a plurality of embodiments individually or in any appropriate sub-combination. Moreover, although features may be described above as acting in specific combinations and even initially claimed as such, one or more features from a claimed combination can in some cases be excised from the combination, and the claimed combination may be changed to a sub-combination or a modification of a sub-combination.

Likewise, although operations are depicted in a predetermined order in the drawings, it should not be construed that the operations need to be performed sequentially or in the predetermined order, which is illustrated to obtain a desirable result, or that all of the shown operations need to be performed. In specific cases, multi-tasking and parallel processing may be advantageous. In addition, it should not be construed that the separation of various device components of the aforementioned embodiments is required in all types of embodiments, and it should be understood that the described program components and devices are generally integrated as a single software product or packaged into a multiple-software product.

The embodiments disclosed in the present specification and the drawings are intended merely to present specific examples in order to aid in understanding of the present disclosure, but are not intended to limit the scope of the present disclosure. It will be apparent to one of ordinary skill in the art that various modifications based on the technical spirit of the present disclosure, as well as the disclosed embodiments, can be made.

What is claimed is:

1. A signal compression method comprising:
outputting an input signal, obtained by processing an audio signal, which is input, based on a human auditory perception characteristic, using an auditory perception model;
extracting a feature vector from the input signal, using a feature extraction module; and
outputting a code obtained by compressing the feature vector using a trained signal compression model.

2. The signal compression method of claim 1, wherein the outputting of the input signal comprises:
filtering the audio signal using a middle ear filter;
determining a first control variable of a step subsequent to a previous step, based on the filtered audio signal and a second control variable according to a first control variable of the previous step, using an outer hair cell group; and
outputting the input signal based on the filtered audio signal and the first control variable of the subsequent step, using an inner hair cell group.

3. The signal compression method of claim 2, wherein
the inner hair cell group comprises a chirping filter, a low-pass filter, and a wideband filter, and
the inner hair cell group is configured to output the input signal, based on a characteristic of the chirping filter determined based on the first control variable of the subsequent step.

4. The signal compression method of claim 2, wherein
the outer hair cell group comprises a control path filter, and a low-pass filter, and
the outer hair cell group is configured to determine the first control variable of the subsequent step based on a characteristic of the control path filter determined based on the second control variable.

5. The signal compression method of claim 1, wherein the signal compression model comprises:
a first neural network model trained to output a latent vector using the feature vector; and
a quantization model trained to output the code based on the latent vector and a codebook.

6. A signal compression apparatus, comprising:
a processor,
wherein the processor is configured to:
output an input signal, obtained by processing an audio signal, which is input, based on a human auditory perception characteristic, using an auditory perception model;
extract a feature vector from the input signal, using a feature extraction module; and
output a code obtained by compressing the feature vector, using a trained signal compression model.

7. The signal compression apparatus of claim 6, wherein the auditory perception model comprises:
a middle ear filter configured to filter the audio signal;
an outer hair cell group configured to determine a first control variable of a step subsequent to a previous step based on the filtered audio signal and a second control variable according to a first control variable of the previous step; and
an inner hair cell group configured to output the input signal based on the filtered audio signal and the first control variable of the subsequent step.

8. The signal compression apparatus of claim 7, wherein
the inner hair cell group comprises a chirping filter, a low-pass filter, and a wideband filter, and
the inner hair cell group is configured to output the input signal, based on a characteristic of the chirping filter determined based on the first control variable of the subsequent step.

9. The signal compression apparatus of claim 7, wherein
is the outer hair cell group comprises a control path filter, and a low-pass filter, and
the outer hair cell group is configured to determine the first control variable of the subsequent step based on a characteristic of the control path filter determined based on the second control variable.

10. The signal compression apparatus of claim 6, wherein the signal compression model comprises:
a first neural network model trained to output a latent vector using the feature vector; and
a quantization model trained to output the code based on the latent vector and a codebook.

11. A signal restoration apparatus, comprising:
a processor,
wherein the processor is configured to:
identify a code; and
output an output signal restored from the code using a trained signal restoration model,
wherein the code is output by compressing a feature vector using a trained signal compression model, and
wherein the feature vector is extracted from an input signal, obtained by processing an audio signal, which is input, based on a human auditory perception characteristic, using an auditory perception model.

12. The signal restoration apparatus of claim 11, wherein the auditory perception model comprises:
a middle ear filter configured to filter the audio signal;
an outer hair cell group configured to determine a first control variable of a step subsequent to a previous step based on the filtered audio signal and a second control variable according to a first control variable of the previous step; and
an inner hair cell group configured to output the input signal based on the filtered audio signal and the first control variable of the subsequent step.

13. The signal restoration apparatus of claim 12, wherein
the inner hair cell group comprises a chirping filter, a low-pass filter, and a wideband filter, and
the inner hair cell group is configured to output the input signal, based on a characteristic of the chirping filter determined based on the first control variable of the subsequent step.

14. The signal restoration apparatus of claim 12, wherein
the outer hair cell group comprises a control path filter, and a low-pass filter, and
the outer hair cell group is configured to determine the first control variable of the subsequent step based on a characteristic of the control path filter determined based on the second control variable.

15. The signal restoration apparatus of claim 11, wherein the signal restoration model comprises:
an inverse quantization model configured to restore a latent vector from the code using a codebook; and
a second neural network model configured to restore the output signal using the latent vector.

16. The signal restoration apparatus of claim 11, wherein the signal compression model comprises:
a first neural network model trained to output a latent vector using the input signal; and
a quantization model trained to output the code based on the latent vector and a codebook.

17. The signal restoration apparatus of claim 15, wherein the signal restoration model, the signal compression model, and the codebook are trained based on a loss function determined based on the feature vector, the latent vector, the code, and the output signal.
